(19) United States
(12) Patent Application Publication
(10) Pub. No.: US 2019/0215938 A1
(43) Pub. Date: Jul. 11, 2019

(54) ILLUMINATION THEATER

(71) Applicant: Telelumen, LLC, Saratoga, CA (US)

(72) Inventor: Steven Paolini, Saratoga, CA (US)

(21) Appl. No.: 16/355,744

(22) Filed: Mar. 16, 2019

Related U.S. Application Data
(63) Continuation-in-part of application No. 15/810,655, filed on Nov. 13, 2017.
Application No. 15/810,655 is a division of application No. 14/943,328, filed on Nov. 17, 2015, now Pat. No. 9,820,360.
(60) Provisional application No. 62/644,264, filed on Mar. 16, 2018.

(51) Int. Cl. H05B 37/02; H05B 33/08

(52) U.S. Cl. CPC H05B 37/0272; H05B 33/086

(57) ABSTRACT

An illumination theater provides illumination for viewing of people and objects and the illumination may be combined with or tailored to accompany activities in the illuminated environment. An illumination theater may further illuminate or include a bathing area, a dining area such as a restaurant, food court, or a healthy space such as a spa, exercise area, conference room, a break room, or anywhere people spend their time.

### CROSS-REFERENCE TO RELATED APPLICATIONS

This patent document is a continuation-in-part and claims benefit of the earlier filing date of U.S. patent application Ser. No. 15/810,655, filed Nov. 13, 2017, which is a divisional of U.S. patent application Ser. No. 14/943,328, filed Nov. 17, 2015, now U.S. Pat. No. 9,820,360, which are hereby incorporated by reference in their entirety. This patent document also claims benefit of the earlier filing date of U.S. Provisional Pat. App. No. 62/644,264, filed Mar. 16, 2018, which is hereby incorporated by reference in its entirety.

### BACKGROUND

Since ancient times people have gathered together to experience performances or conduct activities. The performances could take the form of storytelling, music, a play, a magic show, athletic competitions, rituals, informative lectures, debates, or many other human activities. As time went on purposeful structures were built to enhance those experiences. Outdoor structures such as amphitheaters and stadiums have been built particularly to provide venues for large audiences, but outdoor venues are subject to uncontrolled conditions such as weather and difficult-to-control conditions such as acoustics. Indoor structures or theaters were built for various reasons, for example, to avoid weather and provide better acoustics and more generally to provide a more enjoyable and easier to produce presentation or activity.

Movie theaters were built, beginning in the early part of the last century, to bring visual storytelling through images. Movie theaters focus on visual presentations, and the first movies did not include a sound track although live music might be included when displaying silent movies to add to the experience. Later sound tracks with dialogue, music, and sound effects were added to movies, and movie theaters required audio systems to play sounds that accompanied the visual presentation. In the 1950's, stereophonic sound reproduction was added, and in the late 1970's, surround sound was introduced for the “Star Wars” movie. Each of these enhancements was added to deepen the experience and ideally to make presentations more enjoyable. However, as powerful as these cinema experiences have become, except for the screen, movies take place in the dark, and movie theaters are not suitable for many human activities.

### SUMMARY

In accordance with an aspect of the invention, an illumination theater provides illumination for viewing of people and objects in the illumination theater, and the illumination may be tailored for general entertainment or to enhance specific activities in the illumination theater. For example, the illumination may be combined with, synchronized, or tailored to accompany performances or presentations such as plays or movies. An illumination theater may also provide a healthy space (or healthful space) with illumination that enhances health and well being. Illumination theaters may provide an environment for other activities such as a restaurant, food court, or home dining area for eating, a conference room for exchanges of information, a break room or spa for relaxation, a gym for exercise, or any space where people spend their time.

One specific implementation of an illumination theater includes a lighting system and a control system. The lighting system is configured to illuminate an environment of the illumination theater. The control system operates to select and execute scripts from a library of scripts. The scripts may represent respective illumination that the control system can direct the lighting system to reproduce to illuminate the environment. The library of scripts may include scripts respectively associated with activities to be conducted in the environment, so that at any specific time, the control system may select a script for the activity being conducted in the environment.

### BRIEF DESCRIPTION OF THE DRAWINGS

FIG. 1 is a block diagram of an illumination theater including an illumination system, associated environmental systems, and an interactive object environment.

FIG. 2 is a block diagram of a lighting system or luminaire having multiple independently controllable spectral channels.

FIG. 3 illustrates an implementation of an illumination theater including multiple light sources.

FIG. 4 is a block diagram of an illumination theater for activities such as showering or dressing.

FIG. 5 is a block diagram of a healthy space illumination theater.

FIG. 6 is a block diagram of an illumination theater for dining.

The drawings illustrate examples for the purpose of explanation and are not of the invention itself. Use of the same reference symbols in different figures indicates similar or identical items.

### DETAILED DESCRIPTION

In accordance with an aspect of the present invention, an illumination theater provides lighting to enhance activities, to entertain, to improve experiences, to induce emotions, or to improve the mental or physical conditions of people within the illumination theater. An illumination theater may provide an enhanced movie theater system that provides lighting to accompany video, but an illumination theater may alternatively provide illumination for activities that do not require or involve the display of images. The illumination may provide a background lighting that allows people to see and interact with the environment in the illumination theater, and the illumination may have intensity, spectral power distributions, and directional characteristics, with or without temporal variations, that enhance the interactions and may activate a desirable biological response.

An illumination theater does not require movie theater systems and may be employed with no movie or video at all. In general, an illumination theater could be employed wherever human activities occur to provide illumination and enhance the experience of the activities. Illumination theaters may be large, e.g., on the scale of a stadium, or be small, e.g., on the scale of a room or an area within a business or a private home. An illumination theater may be employed within or as a facility such as a restaurant, a food court, a meeting space, or anywhere humans spend their time and may provide a healthy space in any such facility. In different embodiments, an illumination theater may have one common theme such as a beach, city environment, or forest or may be multi-themed where different vignettes can be commonly housed but individually accessed. An illumination theater may be employed for various human activities such as relaxing, working, partying, seeking inspiration, and play acting. Food, drinks, stimulants or intoxicating substances may also be added to enhance and/or prolong the experience.

Illumination theaters may be used to trigger or enhance, not only psychological reactions but also biological responses. Light and the illumination used to see is known to have significant biological effects on people, animals, and plants. The human brain, for example, processes light both visually and non-visually through numerous types of receptors, and those perceptions have physiological and psychological effects. The non-visual receptors, for example, have a significant impact in biological and physiological functions including circadian rhythms, sleep-wake regulation, alertness, cognition, and mood. Bright polychromatic light is known to suppress melatonin and enhance alertness as well as stimulate the production of serotonin which can elevate mood and a sense of well being. Various bodily functions and emotional states are known to be effected by the intensity, spectrum, duration, timing, and history of illumination experienced. Thyroid hormones, which are influenced by light exposure, can make more glucose available to increase protein synthesis, increase lipid metabolism, and trigger heart and nerve functions. Light, particularly in the blue wavelengths, is known to have significant alerting, cognitive, and circadian phase shifting properties that could be useful for altering one's perspective or creating an artificial reality. Perhaps our visual system has a built in blue sky detector to tell us when its morning and begin our day. Other wavelengths alone and in combinations seem likely to have other important effects such as healing and well being. Perhaps our visual system also has a red sky detector to tell us when it's time to prepare for sleep. Maybe too, our visual system has a fire detector to set a romantic mood or alert us to the danger of being burned. The impacts of illumination may also be affected by other accompanying sensory input such as sounds, scents, and tactile experiences.

Some illumination theaters as disclosed herein employ illumination in combination with other sensory input such as sounds, scents, and tactile experiences. In general, the full range of effects that illumination theaters may achieve using illumination alone or in combination with other sensory input may not be fully known. However, the specific effects of illumination alone or in combination with other sensory input may be determined by techniques such as monitoring hormone levels in blood or saliva and monitoring brain wave activity or cerebral blood flow in a subject experiencing sensor input including illumination. Higher level human interactions such as test taking and interviewing are also valuable assessment tools.

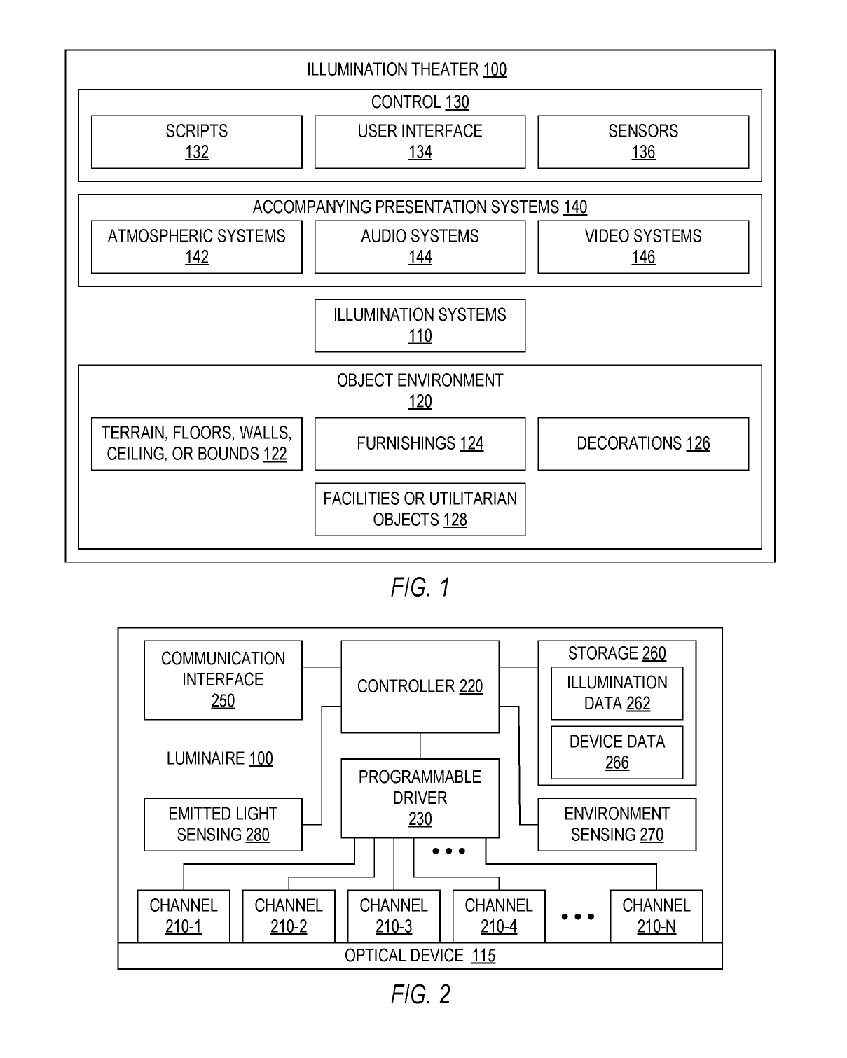

FIG. 1 shows an example implementation of an illumination theater 100 that includes illumination systems 110 with a wide range of optional associated systems. Illumination systems 110 provide illumination to object environment 120, e.g., to terrain, floors, walls, ceilings or other boundaries 122 within or defining a building space assigned to illumination theater 100 and to objects such as furnishings 124, decorations 126, and facilities or utilitarian objects 128 that may be located within illumination theater 100. Boundaries 122 of illumination theater may include: ground materials such as tile, carpet, stone, sand, gravel, or dirt; walls with or without windows and that may be painted or otherwise decorated; and ceiling features that may include the housing or enclosures for some of illumination systems 110. Furnishings 124 may include, for example, indoor furniture, office furniture, and outdoor furniture for human comfort or activity in the illumination theater. Decorations 126 may further include decorative items, which may be inanimate objects or living things such as vegetation such as grass or trees.

The illumination from illumination systems 110, which people in illumination theater 100 use to interact with object environment 120, may be tailored or scripted according to the nature of object environment 120. More specifically, characteristics of the illumination including the intensity or quantity of light, the spectral power distribution (SPD) of the illumination, directional characteristics of the illumination, and spatial and temporal variations of the intensity, SPD, and directional characteristics may be defined by scripts 132. Scripts 132 may particularly include one or more tracks for control of illumination systems 110 and one or more tracks for playing of coordinated presentations. U.S. Pat. No. 9,820,360, entitled “Illumination Content Production and Use,” which is incorporated herein in its entirety, describes methods and structures for producing, editing, and using multi-track scripts.

A control system 130, which executes scripts 132, may include a centralized or distributed computing system and may be a separate device or integrated in illumination systems 110 or other systems in illumination theater 100. Control system 130 will generally include or implement an operating system or user interface 134 that allows a user to download or access scripts 132, provide user preferences regarding execution of scripts 132, and select one from among multiple scripts 132 for immediate execution or execution at user-specified times or in response to user-specified conditions being met. For example, a user preference may specify a time scale or duration for script or a condition that when met causes control system 130 to execute a particular one of scripts 132. Control system 130 may employ sensors 136 to monitor illumination system 110, object environment 120, or accompanying presentation systems 140, to trigger execution of one of scripts 132, or to cause a change or transition during execution of one of scripts 132. Control system 130 may further automatically select scripts or create an environment based on learning the ways users use illumination theater 100. In general, control system 130 may execute one of scripts 132 to control illumination systems 110 and produce a desired illumination with any accompanying presentation(s).

In one implementation, illumination systems 110 employs solid state lighting that provides control of the SPD, quantity of light, timing, and beam shape of light in illumination from illumination systems 110. The control of illumination system 110 facilitates creation of a new type of experience anchored in illumination. Modern lighting systems may provide not just a relatively meager amount of light or a static SPD needed to see but may provide high light levels and dynamic aspects that might naturally be experienced outdoors in the daytime. These light levels may be five hundred times the normal indoor light level. The experience or effect of high illumination levels may be comparable to the experience and effects of sound levels at a rock concert. For example, illumination theater 100 might provide the illumination experience of a tropical island, bonfire, lightning bolts, aurora borealis, and scuba diving. Illumination theater 100 could also provide illumination experiences or events that never occur naturally, but the illumination could stimulate desired human emotions and reactions. Additionally, the SPD and time variations of the illumination may be chosen to elicit reminiscences or an emotional or biological responses that are appropriate or desired for an activity conducted in illumination theater 100.

The experiences that illumination elicits may become more powerful when combined with presentations from other presentation systems 140 that may accompany illumination systems 110. The accompanying presentation systems 140 may, for example, present sound, smell, video, and physical environment with appropriate types and proportions and coordinated with illumination from illumination systems 110. For example, control system 130, which controls illumination system 110, may execute presentation scripts 132 to simultaneously control illumination systems 110 and accompanying presentation systems 140 to provide coordinated and synchronized presentations.

Accompanying presentation systems 140 in the implementation of FIG. 1 specifically includes atmospheric systems 142, audio systems 144, and video systems 146. Atmospheric systems 142 may include conventional devices such as heaters, air conditioners, fans, humidifiers, misters, air fresheners, or aroma dispensers that may alter atmospheric conditions suited or scripted to accompany the illumination from illumination systems 110. Atmospheric systems 142 may particularly change atmospheric environmental conditions such as temperature or humidity and may simulate weather conditions such as wind or rain, all of which may be related to or choreographed with illumination from lighting systems 110. Audio systems 144 may provide sound, e.g., music, noise, or a sound track that is suited or scripted to accompany the illumination from illumination systems 110. Sound systems 144 may employ a variety of configurations including multi-source or multi-directional aspects, e.g., surround sound systems. Video systems 146 may include monitors or other conventional display devices that control systems 130 can operate to present images.

In general, illumination theater 100 could employ illumination systems 110, atmospheric systems 142, and audio systems 144 to produce some emotionally powerful experiences such as increasingly bright fire light spreading over/around perhaps accompanied by sound of crackling wood, smoke smell, and hot air blowing over an audience. In another example, illumination theater 100 could simulate an approaching electrical storm, simulated with sound, flashes of bright illumination, and video images of streaking lightning.

Atmospheric, audio, and video presentations from presentation systems 140 generally do not require illumination to be sensed, although viewing of video may be affected by environmental illumination from illumination system 110. Illumination theater 100 generally employs lighting systems 110 for illumination of object environment 120, and the illumination from lighting systems 110 may be related to the content of object environment 120 or may facilitate human activity or use of object environment 120. Additionally, object environment 120 may include dynamic elements that are viewed using illumination from illumination systems 110 and that control system 130 may control. For example, water may be present in the physical form of features such as a pond, stream, or fountain that may have operations that controller 130 may coordinate with illumination from illumination systems 110. (Alternatively, the presence of water could be simulated in objects such as paintings, displayed video, and/or sound played during the illumination.)

FIG. 2 shows one example of a multi-channel luminaire 200 that may be employed in illumination system 110 of illumination theater 100 of FIG. 1. Luminaire 200 is programmable to emit illumination with an intensity and a spectral power distribution that may vary in a controlled manner. (The term “luminaire” as used herein refers to an electromagnetic radiator generally and is not limited to being a source of visible light.)

Luminaire 200 as shown contains multiple spectral channels 210-1 to 210-N. Spectral channels 210-1 to 210-N may emit light with different emission characteristics, e.g., different spectral power distributions and/or different degrees of collimation, polarization, or coherency. In general, spectral channels 210-1 to 210-N are not intended to be viewed directly but instead provide electromagnetic radiation or illumination in an environment such as in an illumination theater including an object environment that a user views. As noted above, the light from spectral channels 210-1 to 210-N may not be limited to visible light. In particular, spectral channels 210-1 to 210-N may produce electromagnetic radiation with wavelengths longer or shorter than visible light, e.g., infrared or ultraviolet light, for purposes other than human vision or for secondary human viewing effects such as fluorescence or for biological reactions other than viewing. Each spectral channel 210 may include one or more lighting elements, e.g., one or more light emitting diodes (LEDs), organic light emitting diodes (OLEDs), lasers, or other lighting elements, and different spectral channels 210 may respectively contain different types of lighting elements that have different emission characteristics, e.g., respective light emission spectra and/or degrees of collimation, polarization, or coherency. (Although FIG. 2 shows spectral channels 210-1 to 210-N as being spatially separate and separated, lighting elements associated with spectral channels 210-1 to 210-N may be mixed or interwoven across a light emitting area of luminaire 200.) The total illumination that luminaire 200 provides is generally a sum or combination of the light emitted from all of the spectral channels 210-1 to 210-N, and spectral channels 210 collectively may be configured and operated so that luminaire 200 emits a desired spectral power distribution.

The emission spectrum of luminaire 200 generally covers a range of wavelengths that depends on the types of lighting elements employed in spectral channels 210-1 to 210-N and may, for example, cover a range including infrared, visible, and ultraviolet wavelengths. The number N of types of spectral channels 210-1 to 210-N required for luminaire 200 to cover a desired range of electromagnetic wavelengths generally depends on the desired range and the widths of the emitted spectra of spectral channels 210-1 to 210-N. In an exemplary embodiment, spectral channels 210-1 to 210-N may have three to ten, on the order of one hundred, or even more different colors or different peak emission wavelengths in a range from infrared to ultraviolet. In general, a three-channel lighting system, e.g., providing red, green, and blue light channels, is only sufficient to provide a color for light but is insufficient to provide flexibility in the generated SPD. Accordingly, a luminaire providing more than three channels is normally desired or required for programmable illumination. The peak emission wavelengths of spectral channels 210-1 to 210-N can be separated by steps that depend on the shapes of the respective spectral power distributions of spectral channels 210-1 to 210-N. For example, direct emission LEDs having single-peak spectra with a full width at half maximum (FWHM) of about 5 to 50 nm may provide a desirable spectral resolution and cover a range of wavelengths if the emission spectra have peak wavelengths separated by steps of about 5 to 50 nm. Phosphor-converted LEDs have wider spectral power distributions, i.e., larger FWHM, so that fewer spectral channels 210 may be needed to cover the desired wavelength range if some or all of spectral channels 210 are phosphor-converted LEDs, but channels with wider spectral power distributions generally provide lower resolution in reproduction of a desired spectral distribution.

Luminaire 200 may employ an optical device 215 to mix the light output from channels 210 or to control the divergence or directional distribution of light output from luminaire 210. For example, optical device 215 may include a frosted plate of a transparent material to mix light from spectral channels 210-1 to 210-N and provide more spatially uniform lighting that combines light from all channels 210-1 to 210-N. Other combination methods such as light guides, beam splitters, reflectors, polarized reflectors, refractors, lenses, nano-diffusers or other nano-structures may also be used in optical device 215. In some implementations, optical device 215 may be dynamically operable to alter the divergence or directional character of light output from luminaire 200.

Illumination capabilities of luminaire 200 such as the intensity range, the spectral range, the range of available color temperatures, the gamut, the directionality, and the angular distribution of illumination from luminaire 200 generally depend on the specific choices of the number N of spectral channels 210, the types of lighting elements in spectral channels 210, the number of lighting elements of each type, and the types and arrangement of elements in optical device 215. The illumination emitted from luminaire 200 depends on those illumination capabilities and on how the illumination capabilities are controlled or programmed. In the illustrated embodiment, luminaire 200 contains a controller 220 that operates a programmable driver 230 to individually adjust the intensity of light emitted from each of spectral channels 210-1 to 210-N. In particular, the respective intensities emitted from spectral channels 210-1 to 210-N can be independently adjusted to provide lighting that approximates any desired spectral power distribution over the covered range of wavelengths of spectral channels 210-1 to 210-N. Driver 230, for example, may dim or otherwise control the radiation emitted from each of spectral channels 210-1 to 210-N by controlling the applied electrical power, e.g., by pulse width modulation (PWM), amplitude modulation (AM), or direct digital synthesis of the drive signal waveforms applied to the lighting elements of the respective spectral channels 210-1 to 210-N.

Controller 220 may process illumination data 262 and device data 266 to determine how to operate driver 230. Illumination data 262 in particular may represent a desired spectral power distribution of light emitted from luminaire 200, a desired spatial distribution or collimation of light emitted from luminaire 200, and variations over time in the spectral and spatial distributions. For example, U.S. Pat. No. 8,922,570, entitled “Luminaire System,” which is hereby incorporated by reference in its entirety, describes how illumination data may be formatted as or extracted from a script for controller 220 of luminaire 200, and the script may include executable code that controller 220 executes to control the evolution of lighting from luminaire 200.

Illumination data 262 may be stored in a memory or storage 260 or may be available as needed from an external source, e.g., from local network storage or from cloud storage or a service, accessible through a communication interface 250. For example, the illumination data can be streamed or otherwise input into luminaire 200 through communication interface 250 for on-the-fly control of the light emitted from luminaire 200. In an exemplary embodiment, communication interface 250 connects luminaire 200 to a network that may include similar luminaires or control devices, e.g., a light player, and can further be part of a user interface that allows a user to control luminaire 200, for example, to select lighting for an illumination theater containing luminaire 200. Storage system 260 may be any type of system capable of storing information that controller 220 can access. Such systems include but are not limited to volatile or non-volatile IC memory such as DRAM or Flash memory and readers for removable media such as magnetic disks, optical disks, or Flash drives.

Illumination data 262 could have a variety of different formats suitable for representing the desired lighting. In one implementation, illumination is represented using one or more “illumination frames” or one or more sequences of illumination frames, where each illumination frame includes a representation of a spectral power distribution. Illumination data 262 may further include or represent collimation information and directional information for the illumination, for example, to represent a diffuse blue sky or collimated sunlight from a specified direction. For a multi-luminaire system, the illumination data may be partitioned into “tracks” corresponding to different luminaires or different sets of luminaires and may provide information indicating multiple points of origin of illumination based on the locations of the luminaires in the illumination system.

Device data 266 may indicate the characteristics of luminaire 200. Such characteristics of luminaire 200 may include, for example, an identifier for luminaire 200, a maximum or nominal frame rate of luminaire 200, the number N of spectral channels 210 in luminaire 200, data indicating the respective spectral power distributions of light from spectral channels 210, maximum intensities from the respective channels 210, and the response of each channel 210 to current, temperature, or other operating parameters of luminaire 200, and information indicating the position or orientation of luminaire 200 relative to other light sources or to a reference point for an illumination theater incorporating luminaire 200. Device data 266 may be used internally in luminaire 200, e.g., by controller 220 when controller programs driver 230, or externally, e.g., when luminaire 200 communicates its capabilities to an illumination system incorporating luminaire 200.

Luminaire 200 may further include a sensing unit 270. Sensing unit 270 may, for example, include a spectrometer, a plurality of optically filtered photodetectors, a positional sensor, a camera, or other light sensors specific to a desired illumination experience. An emitted light sensing unit 280 may be used to measure the light emitted by luminaire 200. Light sensing unit 280 may differ from environment sensing unit 270 in that emitted light sensor 280 may be configured to isolate and measure light from spectral channels 210-1 to 210-N, while environment sensing unit 270 may measure light from the environment surrounding luminaire 200. Emitted light sensor 280 may be particularly useful for calibration of luminaire 200 or for observing or monitoring the over-time performance of spectral channels 210-1 to 210-N. Alternatively, either light sensing unit 270 or 280 may perform both environmental sensing and emitted light sensing (if desired).

Luminaire 200 may be programmed to produce illumination with any spectral power distribution that is within the covered wavelength range and the intensity and resolution limits of spectral channels 210-1 to 210-N. Luminaire 200 may further be used in an illumination system with other light sources that are spatially distributed to facilitate production of desired spatial or directional patterns in illumination. Each of the characteristics of the illumination may be subject to temporal variations. The time scales for such variation may be slow or fast relative to human perception. For example, lighting that reproduces or approximates the path of solar illumination from dawn to dusk may include spatial, spectral, directional, collimation, and intensity variations that slowly evolve over the course of a day. Lighting that reproduces or approximates the spatial, spectral, directional, collimation, and intensity patterns of a lightning strike could include spatial, spectral, directional, collimation, and intensity variations within a fraction of a second. Illumination systems may play such illumination content at faster or slower speeds and may match or synchronize illumination with presentations, e.g., with audio, video, games, simulations, or any other presentation or user activity.

Luminaire 200 by itself may constitute an illumination system for an illumination theater. However, an illumination system including multiple light sources or luminaires that are spatially distributed in an environment may be better able to more accurately play back lighting with different spatial/directional distributions or variations.

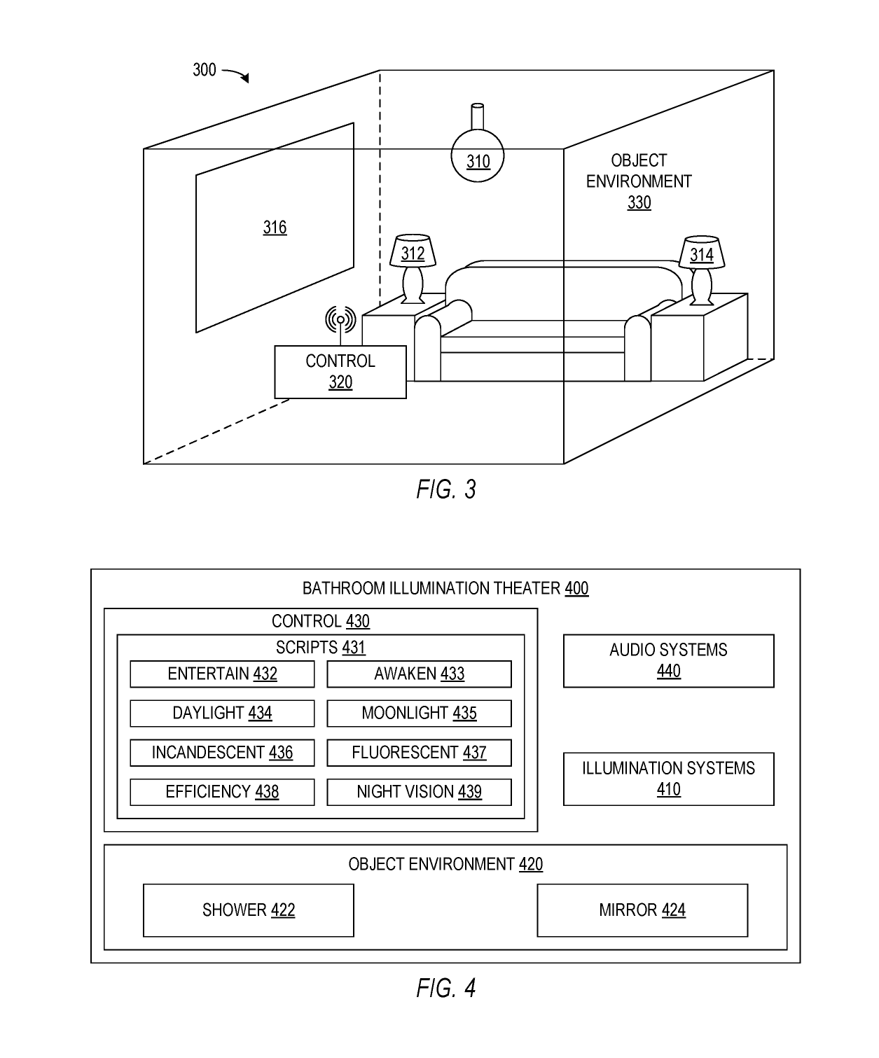

FIG. 3 shows an illumination theater 300 employing an illumination system including multiple light sources 310, 312, 314, and 316. Light sources 310, 312, 314, and 316 may be a combination of different types of light sources that may be arranged in a manner that is unique to illumination theater 300. In one implementation, one or more light sources 310, 312, 314, and 316 may be programmable for cooperative operation under the control of a control system 320, and one or more of light sources 310, 312, 314, and 316 may not be programmable or otherwise under the control of control system 320. For example, one or more light source 310 may be a multi-channel, programmable luminaire capable of reproducing a desired spectral power distribution and may have an interface for communications with control system 320 or other light sources. Another light source 312 or 314 may have only limited electronic control of illumination characteristics. For example, some light sources 312 or 314 may have a controllable intensity or have time of day awareness, with no spectral control, e.g., a fixed spectrum lamp with an network controlled dimmer, and other light sources 316 may produce light over which control system 320 has little or no control, e.g., a window without electronic shades or spectral filtering, but control system 320 may be able to measure characteristics of illumination from uncontrolled light sources and adapt the controllable light sources to compensate. The variety of types of light sources that may be used is unlimited, but some examples of suitable luminaires 310, 312, 314, and 316 may include upper/lower wall luminaires, torchiere/projector luminaires to up-light ceilings or highlight objects, and desk/table lamps. A regularly spaced grid such as ceiling array of luminaires or a flat/thin wall luminaires that resemble windows could be employed in illumination theater 300 in combination with other types of luminaires.

Control system 320 in illumination theater 300 coordinates the light emissions from luminaires of the illumination systems in order to produce the desired illumination of the object environment 330. In particular, control system 320 may be set to provide illumination according to a user's intended activity in illumination theater 300. In general, control system 320 may be a separate device, e.g., special purpose hardware or a computing system executing light player program, or may be implemented within one or more of luminaires 310, 312, 314, or 316 in illumination theater 300.

FIG. 4 is a block diagram of one specific example of an illumination theater 400 that includes a water experience. Illumination theater 400 includes an illumination system 410 that is operated by a control system 430, which may be implemented as described above to execute selected scripts 431. Illumination system 400 further incorporates an object environment 420 including a bathing area or shower 422. In illumination theater 400, which provides a bathing area, control unit 430 includes an executable script 432 that may be appropriate for, may entertain during, or may enhance the experience of showering. For example, control system 430 when executing script 432 may operate illumination systems 410 to provide illumination corresponding to clouded sunlight and periodic flashes of lightning, and according to script 432, control system 430 may simultaneously operate audio systems 440 in illumination theater 400 to play rolls of thunder. As another example suitable for showering, control system 430 may execute a script 433 that over time alters the spectral power distribution (and possibly the intensity) of illumination from illumination systems 410 to trigger a biological response that smoothly awakens and improves the alertness of a user while the user showers. For example, playing of script 433 may cause illumination system 410 to produce illumination with the evolving spectral power distribution of a rising sun and increasing diffuse bluish lighting while audio system 440 provides the early morning sounds of birds or other wildlife. Accordingly, the known biological effects of illumination, such as the effect that the presence or absence diffuse blue light from a blue sky has on human and animal sleep cycles, can be employed.

Illumination theater 400 may not be a single use area, and in the example of FIG. 4, object environment 420 of illumination theater 400 includes a mirror 424 used during the activity of dressing or applying makeup. For such activities, a user may wish to observe their appearance under a specific lighting or under a variety of lighting conditions. In the implementation of FIG. 4, control system 430 includes scripts 434, 435, 436, and 438 that when executed cause illumination systems 410 to produce illumination with spectral power distributions of daylight, moonlight, incandescent lighting, or fluorescent lighting in the area of mirror 424.

Control system 430 may also execute scripts 438 and 439 to optimize specific criteria. For example, script 438 may maximize, at a given power to illumination systems 410, emitted light useful for human vision from the light output. Execution of script 439 may cause illumination systems 410 to produce light with an SPD that preserves human night vision or with an SPD that minimizes disturbance of anyone sleeping nearby.

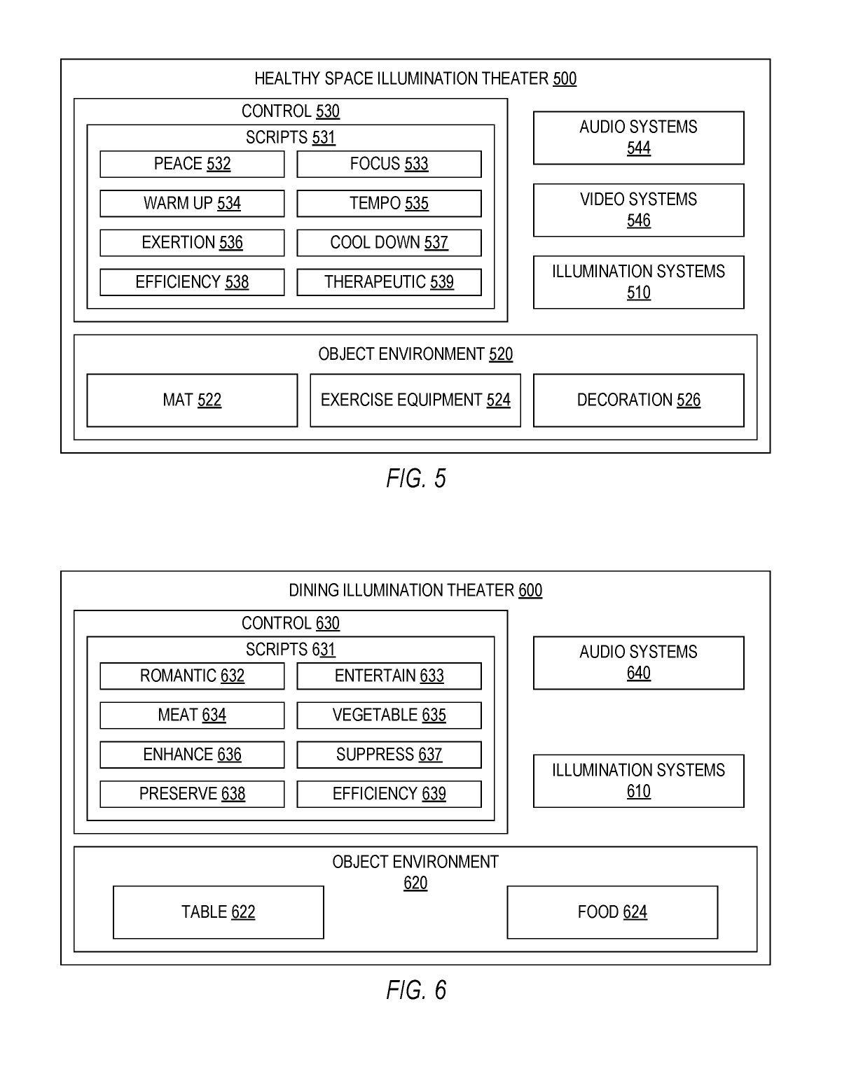

Some other implementations of illumination theaters may create different types of healthy space. A healthy space could be a spa, a place to do yoga or exercise, a quiet place for meditation, or any space where a significant purpose is to improve one's health or well being. FIG. 5 is a block diagram illustrating a healthy space illumination theater 500. Illumination theater 500 includes illumination systems 510 for illuminating object environment 520 and a control system 530 that selects and executes scripts for control of illuminations systems 510 and optional accompanying audio and video presentation system 544 and 546. Object environment 520 in illumination theater 500 may include a workout or yoga mat 522, exercise equipment 524, and mood-setting decorations 526. Control system 530 may be employed to select and execute a script from among a library of available scripts 531 chosen for healthy space illumination theater 500. In particular, scripts 531 may be related to different activities or different stages of an activity conducted in object environment 520 and may be initiated by user selection or by control system 530 sensing commencement or progress of an activity.

Some examples of scripts 531 include a script 532 intended to produce a peace of mind when used in healthy space illumination theater 500. For example, playing script 532 may provide illumination with the SPD of sunlight from a spring day and provide calming music or natural sounds. A script 533 may be implemented to similarly improve a focused mind. Scripts 534, 535, 536, and 537 may be targeted at different types of exercises or different stages of an exercise. For example, warm up script 534 may be similar to peace or focus script 532 or 533, which calm or focus a user's mental state, and may further provide a video of reminders or instructions regarding a users preferred warm up activities to prepare a user for further activities. A tempo script 535 may be oriented to repetitive activities such running on treadmill, cycling on a stationary bicycle, or performing other repetitive or cardiovascular exercises. Tempo script 535 may particularly provide rhythmic variations in illumination from illumination systems 510 and in sound from audio systems 544, and the tempo or frequency of the variations may be a fixed or variable user-setting or set or changed in response to sensing of user activity or operation of exercise equipment 524. A script 536 may be intended for use during periods of peak exertion and may, for example, provide illumination and music that triggers encouraging feelings or feelings of triumph or success. A cool down script 537 may be played for transition, for example, to start with whatever illumination and audio was last being played and transition over time to peaceful or relaxing illumination and audio, e.g., to an illumination represented by peace script 532. Scripts 531 may further include utility scripts such as an efficiency script 538 that maximizes, at a given power to illumination systems 510, emitted light useful for human vision.

Healthy space illumination theater 500 is not limited to exercise locations but may be employed in leisure or work environments to alleviate stress. In an effort to save energy, more and more indoor environments reduce the overall light levels by limiting lighting power density (LPD). LPD is generally expressed as electrical watts used for lighting per unit area (in the US usually watts per square foot). In modern building codes, the maximum indoor LPD may be less than one watt per square foot. These lighting limits and use of control devices such as dimmers may reduce the feeling of a well lit space. Low light levels, while saving energy, may be stressful, depressing, or even unhealthy, particularly over extended periods of time. Healthy-space illumination theater 500 within a building also containing a work environment could help bring a better feeling to workers during break times. For example, healthy space illumination theater 500 may be a break room in an office and may execute peace script 532 to provide people with illumination and a setting that helps relieve stress and helps workers to relax. The object surrounding 520 of break room may be set or decorated as a relaxing scene such as a clearing in the woods, and execution of script 532 may provide high illumination levels with outdoor SPD, wind sounds, birds chirping, and flower fragrance that could transport one's emotions away from the stress of work.

Healthy space illumination theater 500 may also or alternatively be used as a therapy room for various ailments affecting humans, fauna, or flora. These include but are not limited to traumatic brain injury, seasonal affective disorder, migraine headaches, pain mitigation, and skin problems such as acne, psoriasis, eczema, rashes, and hives. Healthy space illumination theater 500 and particularly illumination from playing a therapeutic script 539 in healthy space illumination theater 500 may have direct effects such as curative and stimulation of biological and physiological phenomena including neuroregeneration and biomodulation of natural healing. In general, the specific SPD and intensity needed to cause a biological reaction will depend on the reaction sought. In many cases, healthy space illumination theater 500 may have indirect and placebo effects that improve the well being and or positive feelings of the occupants to the extent that the occupants actually feel better.

FIG. 6 is a block diagram of one specific example of an illumination theater 600 that may be used for dining. An object environment 620 for dining illumination theater 600 would typically include furnishings such as a table and would often include food. Dining illumination theater 600 further includes an illumination system 610 and an audio system 650 that a control system 630 operates to provide illumination and audio in object environment 620. Control system 630 may be implemented as described above to select and execute any of a library of scripts 631 that are chosen for dining illumination theater 600.

Scripts 631 in dining illumination theater 600 may be selected for different aspects of dining. A script 632 may be intended to set a romantic mood by provide subdued illumination such as illumination with a candle or fire light SPD and variations from illumination systems 610 accompanied by user selected music from audio systems 640. An entertaining script 633 may represent a presentation that may be entertaining during a meal such as illumination and sounds that may be found during a picnic or during display of fireworks.

Alternatively, playing other scripts 634 and 635 may provide illumination that may be selected for the food being eaten. For example, execution of a meat script 634 may produce illumination with an SPD with relatively more power in red light, so that the reds or browns in the appearance of meat may be prominent and appealing. A vegetable script 635 may produce illumination with an SPD with relatively more power in green light, so that the appearance of green vegetables may be more appealing. More generally, types of food and drinks that may be found in illumination theater 600 could be enhanced in appearance using illumination with an SPD scripted to emphasize the parts of the spectrum that reflect the most pleasing characteristics of the food or drink. For example saturating reds for wine and meat, or yellows for breads and pastries, or blues for cold drinks may improve the overall experience of a diner. Other scripts 636 and 637 may be intended to enhance or suppress appetite. Such effects on appetite may be achieved either by producing an SPD for illumination that alters the appearance of foods so that foods look appealing to improve appetite or foods look unnatural or unappealing to suppress appetite. Alternatively, execution of a script 636 or 637 could produce an SPD to trigger a biological reaction that directly impacts the diner's appetite. For yet another type of script, spectral engineering in a preservation script 638 may aid in reducing the concentration of bacteria on objects and humans in object environment 620 and/or may prolong the shelf or useful life of food 624 in object environment 620. Scripts 631 may also include utility base scripts such as a script 639 that maximizes, at a given power to illumination systems 610, emitted light useful for human vision.

All or portions of some of the above-described systems and methods can be implemented in a computer-readable media, e.g., a non-transient media, such as an optical or magnetic disk, a memory card, or other solid state storage containing instructions that a computing device can execute to perform specific processes that are described herein. Such media may further be or be contained in a server or other device connected to a network such as the Internet that provides for the downloading of data and executable instructions.

Although particular implementations have been disclosed, these implementations are only examples and should not be taken as limitations. Various adaptations and combinations of features of the implementations disclosed are within the scope of the following claims.

what is claimed is:

1. A system comprising:
a lighting system configured to illuminate an environment; and
a control system coupled to control the lighting system and configured to select and execute a script from among a plurality of scripts, the scripts representing respective illumination that the control system directs the lighting system to reproduce to illuminate the environment in response to the control system executing the script, wherein
the plurality of scripts include scripts respectively associated with activities to be conducted in the environment.

2. The system of claim 1, further comprising an audio system, wherein the scripts further represent respective audio that the control system directs the audio system to reproduce in the environment while the control system executes the script.

3. The system of claim 1, further comprising a video system, wherein the scripts further represent respective video that the control system directs the video system to reproduce while the control system executes the script.

4. The system of claim 1, further comprising an atmospheric system, wherein the scripts further represent respective operations of the atmospheric system that the control system directs the atmospheric system to reproduce while the control system executes the script.

5. The system of claim 4, the operations of the atmospheric system comprise one or more of a heater, an air conditioner, a fan, a humidifier, a mister, an air freshener, and an aroma dispenser.

6. The system of claim 1, wherein the environment includes a bathing area, and the plurality of scripts includes one or more first scripts associated with and played while a user showers in the bathing area.

7. The system of claim 6, wherein the first scripts includes at least one of:
a script representing illumination at a sunrise; and
a script representing outdoor illumination during a storm.

8. The system of claim 6, wherein the environment includes a mirror, and the plurality of scripts includes a plurality of second scripts representing illumination respectively characteristic of a plurality of light sources.

9. The system of claim 8, wherein the second scripts include one or more of:
a script representing sunlight;
a script representing moonlight;
a script representing light from an incandescent light fixture; and
a script representing light from an incandescent light source;

10. The system of claim 1, wherein the environment includes a mirror, and the plurality of scripts includes a plurality of first scripts representing illumination respectively characteristic of a plurality of light sources.

11. The system of claim 10, wherein the first scripts include one or more of:
a script representing sunlight;
a script representing moonlight;
a script representing light from an incandescent light fixture; and
a script representing light from an incandescent light source;

12. The system of claim 1, wherein the environment comprises a dining area, the plurality of scripts includes one or more first scripts associated with foods and played while the foods are in the dining area.

13. The system of claim 12, wherein the first scripts includes at least one of:
a script representing illumination with a spectral power distribution that enhances the appearance of meat;
a script representing illumination with a spectral power distribution that makes meat appear less appealing;
a script representing illumination with a spectral power distribution that enhances the appearance of green vegetables; and
a script representing illumination with a spectral power distribution that makes vegetables appear less appealing.

14. The system of claim 1, wherein the environment includes one of a break room, a spa, an exercise area, a meditation area, and wherein the plurality of scripts includes illumination having a spectral power distribution and a level of an illumination in an outdoor environment.

15. The healthy space of claim 14, wherein the environment illuminated decor including elements of the outdoor environment.
